(19) United States
(12) Patent Application Publication
(10) Pub. No.: US 2016/0334880 A1
(43) Pub. Date: Nov. 17, 2016

(54) GESTURE RECOGNITION METHOD, COMPUTING DEVICE, AND CONTROL DEVICE

(71) Applicant: SAMSUNG ELECTRONICS CO., LTD., Suwon-si (KR)

(72) Inventors: Philippe FAVRE, En Lombard Vaud (CH); Evgeny KRYUKOV, Suwon-si (KR)

(21) Appl. No.: 15/151,711

(22) Filed: May 11, 2016

(30) Foreign Application Priority Data
May 12, 2015 (KR) 10-2015-0066246

(51) Int. Cl. G06F 3/01; G06K 9/00

(52) U.S. Cl. CPC G06F 3/017; G06K 9/00335

(57) ABSTRACT

Disclosed are a gesture recognition method, a non-transitory computer readable recording medium having recorded thereon a program for executing the gesture recognition method, a computing device, and a control device. The gesture recognition method includes receiving signals of a plurality of motion features; detecting a variable gesture frame from the signals; extracting a feature sample from the variable gesture frame; and determining a gesture command corresponding to the extracted feature sample.

### CROSS-REFERENCE TO RELATED APPLICATION

This application is based on and claims priority under 35 U.S.C. §119 to Korean Patent Application No. 10-2015-0066246, filed on May 12, 2015, in the Korean Intellectual Property Office, the disclosure of which is incorporated by reference herein in its entirety.

### BACKGROUND

1. Field

The present disclosure relates to a gesture recognition method, a computing device, and a control device.

2. Description of Related Art

Various sensors are widely used in most of portable devices. User may use information provided by accelerometers and Gyroscope sensors, thereby naturally and intuitively controlling a remote control device.

Acceleration and a gyroscope signals may include unwanted noise, for example, a behavioral movement of a user sensor, etc. In general, a signal may be filtered in a preprocessing step, which may cause a loss in information.

Signals indicating separate human movement gestures may be very variable and nonstructural, and thus it is a very difficult job to recognize the signals.

Conventional classification methods may not change a system in accordance with a specific user since the system cannot be corrected after being released.

### SUMMARY

A method of effectively recognizing gesture recognition performance, a non-transitory computer readable recording medium having recorded thereon a program for executing the method, a computing device, and a control device are provided.

Additional aspects will be set forth in part in the description which follows and, in part, will be apparent from the description.

According to an aspect of an example embodiment, a gesture recognition method includes receiving signals indicating a plurality of motion features; detecting a variable gesture frame from the signals; extracting a feature sample from the variable gesture frame; and determining a gesture command corresponding to the extracted feature sample.

The detecting of the variable gesture frame may include: determining whether each of the signals is a gesture component or a non-gesture component; and determining a length of the variable gesture frame based on a ratio of the gesture components to the non-gesture components.

The determining of the length of the variable gesture frame based on the ratio of the gesture components to the non-gesture components may include: determining a threshold value based on a ratio of the gesture components to the non-gesture components which are detected in a predefined section of the signals; and setting a start point of the variable gesture frame based on a time point when the ratio of the gesture components to the non-gesture components of the signals equals the threshold value, increasing the length of the variable gesture frame based on whether the ratio of the gesture components to the non-gesture components of the signals exceeds the threshold value, and determining an end point of the variable gesture frame based on a time point when the ratio of the gesture components to the non-gesture components of the signals decreases below the threshold value.

The extracting of the feature sample from the variable gesture frame may include: extracting an intrinsic feature from the variable gesture frame; extracting a high level feature from a gesture sample of the variable gesture frame; and obtaining the feature sample based on a combination of the intrinsic feature and the high level feature.

The receiving of the signals indicating the plurality of motion features may include: receiving the signals indicating the plurality of motion features from an accelerometer and a gyroscope.

According to an aspect of another example embodiment, a non-transitory computer-readable recording medium having recorded thereon a program, which when executed by a computer, performs gesture recognition including receiving signals indicating a plurality of motion features; detecting a variable gesture frame from the signals; extracting a feature sample from the variable gesture frame; and determining a gesture command corresponding to the extracted feature sample.

According to an aspect of another example embodiment, a computing device includes: a communicator comprising communication circuitry configured to receive, from a control device, signals indicating a plurality of motion features; and a controller configured to determine a gesture command corresponding to the received signals and control the computing device to perform an action corresponding to the gesture command, and wherein the controller, in determining the gesture command, is configured to detect a variable gesture frame from the received signals, extract a feature sample from the variable gesture frame, and determine a gesture command corresponding to the extracted feature sample.

The controller, in detecting the variable gesture frame, may be configured to determine whether each of the signals is a gesture component or a non-gesture component and determine a length of the variable gesture frame based on a ratio of the gesture components to the non-gesture components.

The controller may be configured to determine a threshold value based on a ratio of the gesture components to the non-gesture components which are detected in a predefined section of the signals, set a start point of the variable gesture frame based on a time point when the ratio of the gesture components to the non-gesture components of the signals equals the threshold value, increase the length of the variable gesture frame based on whether the ratio of the gesture components to the non-gesture components of the signals exceeds the threshold value, and determine an end point of the variable gesture frame based on a time point when the ratio of the gesture components to the non-gesture components of the signals decreases below the threshold value.

The controller, in extracting the feature sample from the variable gesture frame, may be configured to extract an intrinsic feature from the variable gesture frame, extract a high level feature by filtering a gesture sample of the variable gesture frame, and obtain the feature sample based on a combination of the intrinsic feature and the high level feature.

According to an aspect of another example embodiment, a control device includes: a communicator comprising communication circuitry; a sensor configured to sense motion of the control device and signals indicating a plurality of motion features; and a controller configured to determine a gesture command corresponding to the signals sensed by the sensor and to control the communicator to transmit the gesture command to an external device, and wherein the controller, in determining the gesture command, is configured to detect a variable gesture frame from the signals sensed by the sensor, extract a feature sample from the variable gesture frame, and determine a gesture command corresponding to the extracted feature sample.

### BRIEF DESCRIPTION OF THE DRAWINGS

These and/or other aspects will become apparent and more readily appreciated from the following detailed description, taken in conjunction with the accompanying drawings, in which like reference numerals refer to like elements, and wherein:

FIG. 1 is a reference diagram for describing a gesture recognition movement according to an embodiment;

FIG. 2 is a schematic block diagram of a display device according to an embodiment;

FIG. 3A is a detailed configuration diagram of a display device according to an embodiment;

FIG. 3B illustrates an example of a mapping table of gestures and commands that are used in a gesture recognition module;

FIG. 4A is a block diagram of a configuration of a control device according to an embodiment;

FIG. 4B illustrates an example of a remote control device according to an embodiment;

FIG. 5A is a reference diagram for describing a system that receives a motion feature signal from a remote control device and recognizes a gesture in a display device according to an embodiment;

FIG. 5B is a diagram for describing a system that determines a gesture command corresponding to a motion feature signal in a remote control device and transmits the determined gesture command to a display device according to an embodiment;

FIG. 6 is a flowchart of a process of recognizing a gesture corresponding to a motion feature signal according to an embodiment;

FIG. 7 is a detailed flowchart of a process of extracting a feature sample from a variable gesture frame according to an embodiment;

FIG. 8 is a reference diagram for describing a process of detecting a variable gesture frame from streaming data containing signals indicating a plurality of motion features;

FIG. 9 is a reference diagram for describing a process of detecting a variable gesture frame from streaming data;

FIGS. 10A, 10B and 10C are reference diagrams for describing a variable gesture frame;

FIG. 11 is a reference diagram for describing a method of extracting a gesture sample from a gesture frame according to an embodiment;

FIG. 12 is a reference diagram for describing a method of extracting a high level feature from a gesture sample according to an embodiment;

FIG. 13 is a reference diagram for describing a method of extracting a gesture command corresponding to a signal that a combination of an intrinsic feature and a high level feature according to an embodiment;

FIG. 14 is a diagram for describing an application of adapting a gesture with respect to each of a plurality of users;

FIG. 15 is a diagram for describing an application example defining a customized gesture;

FIG. 16 is a diagram for describing an application example defining a signature gesture; and

FIGS. 17 through 19 are graphs for describing performance of a system to which a gesture recognition method according to an example is applied.

### DETAILED DESCRIPTION

Reference will now be made in greater detail to embodiments, examples of which are illustrated in the accompanying drawings, wherein like reference numerals refer to like elements throughout. Also, a structure of an electronic device and a method of operating the electronic device according to an embodiment will be described in detail with reference to the accompanying drawings.

It will be understood that, although the terms ‘first’, ‘second’, ‘third,’ etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the scope of the disclosure. The term ‘and/or’ includes any and all combinations of one or more of the associated listed items.

The terminology used herein is for the purpose of describing particular embodiments only and is not intended to be limiting of the disclosure. As used herein, the singular forms ‘a’, ‘an’ and ‘the’ are intended to include the plural forms as well, unless the context clearly indicates otherwise. It will be further understood that the terms ‘comprise’ and/or ‘comprising,’ when used in this specification, specify the presence of stated features, integers, steps, operations, elements, and/or components, but do not preclude the presence or addition of one or more other features, integers, steps, operations, elements, components, and/or groups thereof. Expressions such as “at least one of,” when preceding a list of elements, modify the entire list of elements and do not modify the individual elements of the list.

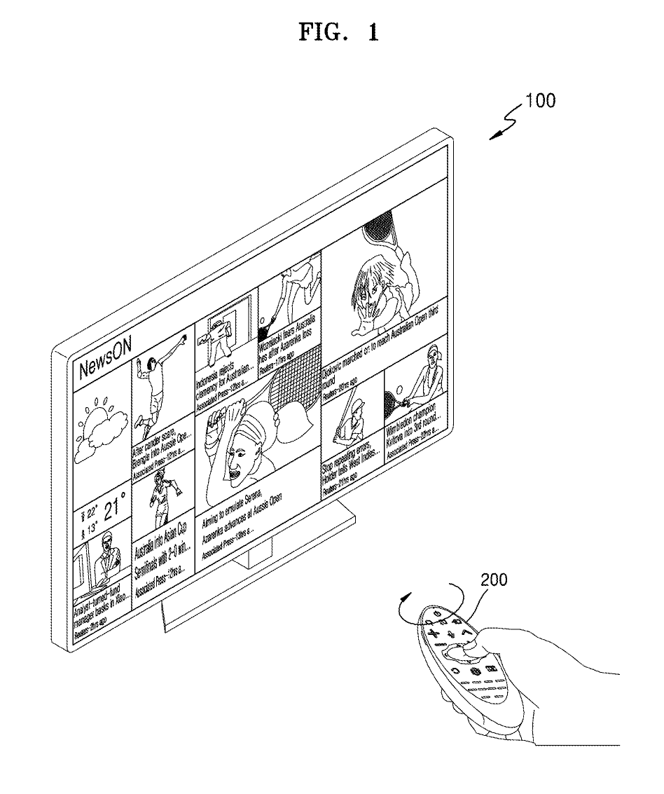

FIG. 1 is a reference diagram for describing a gesture recognition movement according to an embodiment.

Referring to FIG. 1, if a user performs a gesture matching a preset gesture while holding a control device 200, the control device 200 may transmit a gesture signal to a display device 100.

The display device 100 may receive the gesture signal from the control device 200, may determine a command corresponding to the gesture signal, and may act in accordance with the determined command. The display device 100 may store a table that maps various gesture signals and commands to the gesture signals therein, if the gesture signal is received from the control device 200, may discover a command corresponding to the gesture signal from the mapped table, and may determine the corresponding command.

For example, a user's gesture may be determined in various ways, a movement to the right or left, a movement up or down, a circular movement, a movement in a V-shape, etc.

For example, the command may be determined in various ways, volume up/down, channel up/down, zoom in/out, etc.

As described above, when the user wants to control the display device 100, the user may control the display device 100 by inputting a user gesture while holding the control device 200, in addition to merely pressing or pointing a button provided in the control device 200, thereby more conveniently and intuitively controlling the display device 100.

The control device 200 shown in FIG. 1 is an example and may be any type of control device including a sensor capable of recognizing the user's gesture.

The display device 100 shown in FIG. 1 is an example, may be any type of display device that determines the command corresponding to the user's gesture and acts in accordance with the determined command, and may use any term including a computing device or an electronic device.

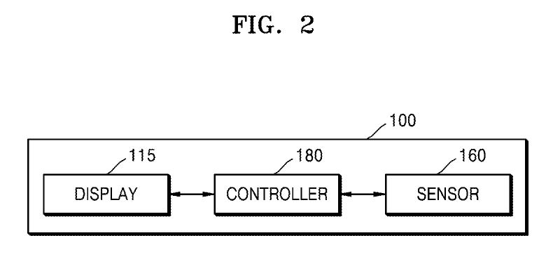

FIG. 2 is a schematic block diagram of the display device according to an embodiment.

Referring to FIG. 2, the display device 100 may include a display 115, a controller (e.g., including processing circuitry) 180, and a sensor 160.

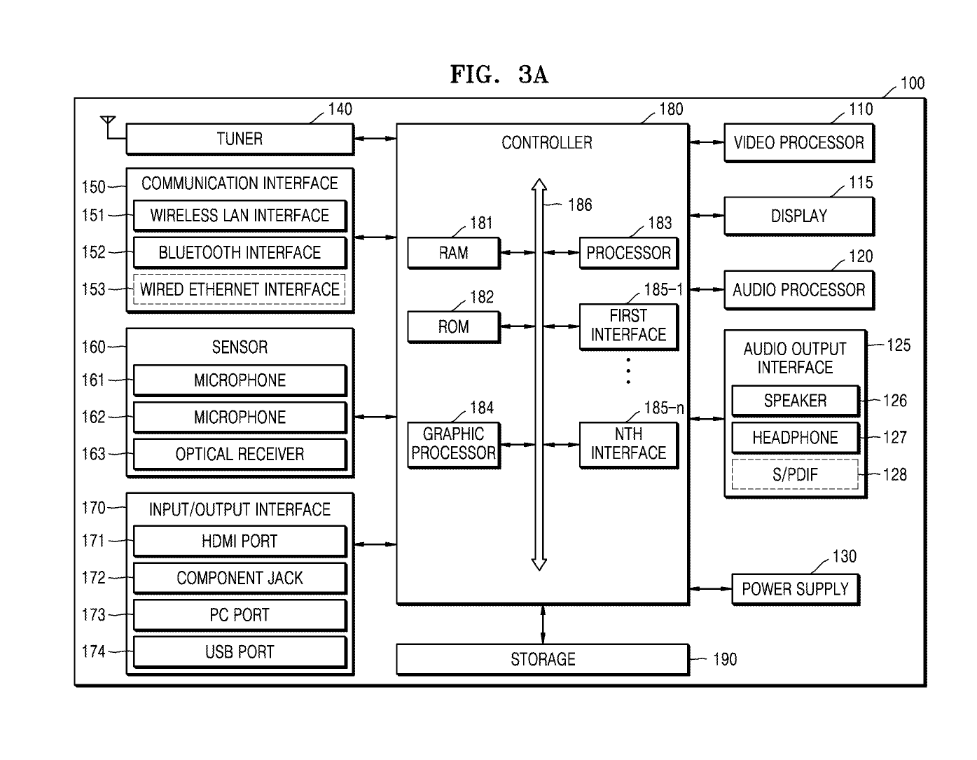

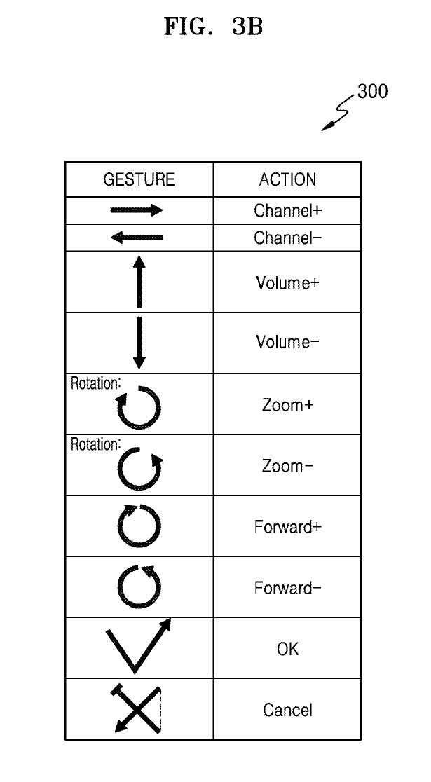

The display 115 may perform an action corresponding to a gesture command or may provide an output corresponding to the gesture command. The display 115 is illustrated as an example in FIG. 2 but is not limited thereto. For example, the display 115, an audio output interface 125, a power supply 130, a communicator (e.g., including communication circuitry) 150, and an input/output interface 170, and a storage 190 shown in FIG. 3A may be constitutional elements that perform the action corresponding to the gesture command.

The sensor 160 may sense a user input of a control device for controlling the display device 100. Control of the display device 100 may include control of a constitutional element for an operation of the display device 100, such as control of the display 115 of the display device 100, control of the audio output interface 125 of the display device 100, control of the input/output interface 170 of the display device 100, control of the power supply 130 of the display device 100, etc.

According to an embodiment, the sensor 160 may receive signals corresponding to motion features of the control device 200. According to an embodiment, the sensor 160 may receive the signals corresponding to the motion features of the control device 200 through the communicator 150.

The controller 180 may determine a gesture command corresponding to the received signals indicating the motion features of the control device 200 through the sensor 160 and may control the output interface 105 to perform an action corresponding to the determined gesture command.

According to an embodiment, to determine the gesture command, the controller 180 may detect a variable gesture frame from the signals indicating the plurality of motion features, may extract a feature sample from the variable gesture frame, and may determine the gesture command corresponding to the extracted feature sample.

FIG. 3A is a detailed configuration diagram of the display device 100 according to an embodiment.

Referring to FIG. 3, the display device 100 may include a video processor 110, the display 115, an audio processor 120, the audio output interface 125, the power supply 130, a tuner 140, the communication interface 150, the sensor 160, the input/output interface 170, the controller 180, and the storage 190.

The video processor 110 may process video data received by the display device 100. The video processor 110 may perform various types of image processing, such as decoding, scaling, noise filtering, frame rate conversion, and resolution conversion, on the video data.

The display 115 may display video included in a broadcast signal received through the tuner 140 on a screen under control of the controller 180. The display 115 may also display content (e.g., a moving image) input through the communication interface 150 or the input/output interface 170. The display 115 may display an image stored in the storage 190 under control of the controller 180. The display 115 may display a voice UI (e.g., including a voice command guide) for performing a voice recognition task corresponding to voice recognition or a motion UI (e.g., including a user motion guide for motion recognition) for performing a motion recognition task corresponding to motion recognition.

According to an embodiment, the display 115 may control a display of the screen according to a gesture command corresponding to a motion feature of the control device 200 under control of the controller 180.

The audio processor 120 may process audio data. The audio processor 120 may perform various types of processing, such as decoding, amplification, and noise filtering, on the audio data. The audio processor 120 may include a plurality of audio processing modules for processing audio corresponding to a plurality of pieces of content.

The audio output interface 125 may output audio included in the broadcast signal received through the tuner 140 under control of the controller 180. The audio output interface 125 may output audio (e.g., a voice or sound) input through the communication interface 150 or the input/output interface 170. The audio output interface 125 may output audio stored in the storage 190 under control of the controller 180. The audio output interface 125 may include at least one of a speaker 126, a headphone output terminal 127, and a Sony/Philips digital interface (S/PDIF) output terminal 128. The audio output interface 125 may include a combination of the speaker 126, the headphone output terminal 127, and the S/PDIF output terminal 128.

According to an embodiment, the audio output interface 125 may control an output of audio according to the gesture command corresponding to the motion feature of the control device 200 under control of the controller 180.

The power supply 130 may supply power input from an external power source to the internal components 110 through 190 of the display device 100 under control of the controller 180. The power supply 130 may supply power input from one or more batteries (not shown) located inside the display device 100 to the internal components 110 through 190 under control of the controller 180.

According to an embodiment, the power supply 130 may control power according to the gesture command corresponding to the motion feature of the control device 200 under control of the controller 180.

The tuner 140 may receive a broadcast signal received via wired or wirelessly by means of amplification, mixing, resonance, and the like and tune and select only a frequency of a channel that the display device 100 desires to receive from among a lot of electronic waves of the received broadcast signal. The broadcast signal may include audio, video, and additional information (e.g., an electronic program guide (EPG)).

The tuner 140 may receive the broadcast signal in a frequency band corresponding to a channel number (e.g., cable station number 506) according to a user input (e.g., a control signal received from the control device 200, for example, a channel number input, a channel up-down input, and a channel input on an EPG screen image).

According to an embodiment, the tuner 140 may select the broadcast signal according to the gesture command corresponding to the motion feature of the control device 200 under control of the controller 180.

The communication interface 150 may include one of a wireless LAN interface 151, a Bluetooth interface 152, and a wired Ethernet interface 153 in correspondence with performance and structure of the display device 100. The communication interface 150 may include a combination of the wireless LAN interface 151, the Bluetooth interface 152, and the wired Ethernet interface 153. The communication interface 150 may receive a control signal of the control device 200 under control of the controller 180. The control signal may be implemented as a Bluetooth-type signal, a radio frequency (RF) type signal, or a Wi-Fi type signal. The communication interface 150 may further include other short-distance communication interfaces (e.g., an NFC interface (not shown) and a BLE interface (not shown)) besides the Bluetooth interface 152.

According to an embodiment, the communication interface 150 may perform a function according to the gesture command corresponding to the motion feature of the control device 200 under control of the controller 180.

The sensor 160 may sense a voice of the user, an image of the user, or an interaction of the user.

A microphone 161 may receive a voice uttered by the user. The microphone 161 may convert the received voice into an electrical signal and output the converted electrical signal to the controller 180. The voice of the user may include, for example, a voice corresponding to a menu or function of the display device 100. A recognition range of the microphone 161 may be recommended to be within 4 m from the microphone 161 to a location of the user, and may vary in correspondence with volume of the voice of the user and an ambient environment (e.g., a speaker sound, and ambient noise).

It will be easily understood to one of ordinary skill in the art that the microphone 161 may be omitted according to the performance and structure of the display device 100.

A camera 162 may receive an image (e.g., continuous frames) corresponding to a motion of the user including a gesture within a camera recognition range. For example, a recognition range of the camera 162 may be a distance within 0.1 m to 5 m from the camera 162 to the user. The motion of the user may include, for example, motion using any body part of the user, such as the face hands, feet, etc., and the motion may be, for example, a change in facial expression, curling the fingers into a fist, spreading the fingers, etc. The camera 162 may convert the received image into an electrical signal and output the converted electrical signal to the controller 180 under control of the controller 180.

The controller 180 may select a menu displayed on the display device 100 by using a recognition result of the received motion or perform a control corresponding to the motion recognition result. For example, the control may include a channel adjustment, a volume adjustment, or a movement of an indicator.

The camera 162 may include a lens (not shown) and an image sensor (not shown). The camera 162 may support optical zoom or digital zoom by using a plurality of lenses and image processing. The recognition range of the camera 162 may be variously set according to an angle of the camera 162 and an ambient environment condition. When the camera 162 includes a plurality of cameras, a 3D still image or a 3D motion may be received using the plurality of cameras.

It will be easily understood to one of ordinary skill in the art that the camera 162 may be omitted according to the performance and structure of the display device 100.

An optical receiver 163 may receive an optical signal (including a control signal) received from the control device 200 through an optical window (not shown) of a bezel of the display 115. The optical receiver 163 may receive the optical signal corresponding to a user input (e.g., a touch, a push, a touch gesture, a voice, or a motion) from the control device 200. The control signal may be extracted from the received optical signal under control of the controller 180.

According to an embodiment, the optical receiver 163 may receive signals corresponding to motion features of the control device 200 and may transmit the signals to the controller 180. For example, if the user moves the control device 200 while holding the control device 200, the optical receiver 163 may receive signals corresponding to motion features of the control device 200 and may transmit the signals to the controller 180.

The input/output interface 170 may receive video (e.g., a moving picture, etc.), audio (e.g., a voice or music, etc.), and additional information (e.g., an EPG, etc.), and the like from the outside of the display device 100 under control of the controller 180. The input/output interface 170 may include one of a high definition multimedia interface (HDMI) port 171, a component jack 172, a PC port 173, and a USB port 174. The input/output interface 170 may include a combination of the HDMI port 171, the component jack 172, the PC port 173, and the USB port 174.

The input/output interface 170 according to an embodiment may perform an input/output function according to the gesture command corresponding to the motion feature of the control device 200 under control of the controller 180.

It will be easily understood to one of ordinary skill in the art that a configuration and operation of the input/output interface 170 may be variously implemented according to embodiments.

The controller 180 may control a general operation of the display device 100 and a signal flow between the internal components 110 through 190 of the display device 100 and process data. If a user input exists, or a preset and stored condition is satisfied, the controller 180 may execute an OS and various applications stored in the storage 190.

The controller 180 may include a RAM 181 used to store a signal or data input from the outside of the display device 100 or used as a storage region corresponding to various operations performed by the display device 100, a ROM 182 in which a control program for controlling the display device 100 is stored, and a processor 183.

The processor 183 may include a GPU (not shown) for processing graphics corresponding to video. The processor 183 may be implemented by an SoC in which a core (not shown) and a GPU (not shown) are integrated. The processor 183 may also include a single core, a dual core, a triple core, a quad core, and a multiple core.

The processor 183 may also include a plurality of processors. For example, the processor 183 may be implemented as a main processor (not shown) and a sub processor (not shown) operating in a sleep mode.

A graphic processor 184 may generate a screen including various objects, such as an icon, an image, and a text, by using a computation unit (not shown) and a renderer (not shown). The computation unit may compute an attribute value such as a coordinate value, a shape, a size, a color, etc., in which each object is to be displayed according to a layout of the screen by using a user interaction sensed by the sensor 160. The renderer may generate the screen of various layouts including the objects based on the attribute value computed by the computation unit.

First to nth interfaces 185-1 through 185-n may be connected to the various components described above. One of the first to nth interfaces 185-1 through 185-n may be a network interface connected to an external device over a network.

The RAM 181, the ROM 182, the processor 183, the graphic processor 184, and the first to nth interfaces 185-1 through 185-n may be connected to each other via an internal bus 186.

In the present embodiment, the term “controller of a display device” includes the processor 183, the ROM 182, and the RAM 181.

The controller 180 may receive the signal indicating the motion feature of the control device 200 through at least one of the optical receiver 163 receiving light output from the control device 200 or the communicator 150.

According to an embodiment, the controller 180 may determine gesture commands corresponding to signals indicating a plurality of motion features received from the control device 200 and may control at least one of components of the display device 100 to perform actions corresponding to the gesture commands.

According to an embodiment, the controller 180 may detect a variable gesture frame from the signals indicting the plurality of motion features, may extract a feature sample from the variable gesture frame, and may determine a gesture command corresponding to the extracted feature sample.

According to an embodiment, to determine the variable gesture frame, the controller 180 may determine each signal as a gesture component and a non-gesture component and may variably determine a length of the feature frame based on the a ratio of the gesture component and the non-gesture component.

According to an embodiment, the controller 180 may determine the ratio of the gesture component and the non-gesture component of the signals detected in a predefined section as a threshold value, and, if the ratio of the gesture component and the non-gesture component of the signals starts to satisfy the threshold value, may determine a start point of the gesture frame, if the ratio of the gesture component and the non-gesture component of the signals exceeds the threshold value, may increase the length of the gesture frame, and, if the ratio of the gesture component and the non-gesture component of the signals is smaller than the threshold value, may determine an end point of the gesture frame.

According to an embodiment, to extract the feature sample from the variable gesture frame, the controller 180 may extract an intrinsic feature from the variable gesture frame, may extract a high level feature by filtering a gesture sample of the variable gesture frame, may combine the intrinsic feature and the high level feature, and may obtain the feature sample.

It will be easily understood to one of ordinary skill in the art that a configuration and operation of the controller 180 may be variously implemented according to embodiments.

The storage 190 may store various data, programs, or applications for operating and controlling the display device 100 under control of the controller 180. The storage 190 may store signals or data input/output in correspondence with operations of the video processor 110, the display 115, the audio processor 120, the audio output interface 125, the power supply 130, the tuner 140, the communication interface 150, the sensor 160, and the input/output interface 170. The storage 190 may store control programs for controlling the display device 100 and the controller 180, applications initially provided from a manufacturer or downloaded from the outside, graphic user interfaces (GUIs) related to the applications, objects (e.g., images, text, icons, and buttons) for providing the GUIs, user information, documents, databases (DBs), or related data.

According to an embodiment, the term “storage” includes the storage 190, the ROM 182 of the controller 180, the RAM 181 of the controller 180, or a memory card (e.g., a micro SD card or a USB memory, not shown) mounted in the display device 100. The storage 290 may also include a nonvolatile memory, a volatile memory, an HDD, or an SSD.

The storage 190 may include a display control module according to an embodiment and may be implemented in a software manner in order to perform a display control function. The controller 180 may perform each function by using the software stored in the storage 190.

According to an embodiment, the storage 190 may include a gesture recognition module controlling at least one of components of the display device 100 in order to determine the gesture command corresponding to the signal indicting the motion feature of the control device 200 and perform the action corresponding to the gesture command.

According to an embodiment, the storage 190 may store a mapping table of gestures and commands that are used in the gesture recognition module.

FIG. 3B illustrates an example of a mapping table 300 of gestures and commands that are used in a gesture recognition module.

Referring to FIG. 3B, a gesture of holding a control device and moving the control device to the right may correspond to a channel-up according to an example.

According to an example, a gesture of holding the control device and moving the control device to the left may correspond to a channel-down.

According to an example, a gesture of holding the control device and moving the control device up may correspond to a volume-up.

According to an example, a gesture of holding the control device and moving the control device down may correspond to a volume-down.

According to an example, a gesture of holding the control device and twisting or moving the control device clockwise while an end point and a start point of the gesture are not identical may correspond to a zoom-in command.

According to an example, a gesture of holding the control device and twisting or moving the control device counterclockwise while the end point and the start point of the gesture are not identical may correspond to a zoom-out command.

According to an example, a gesture of holding the control device and twisting or moving the control device clockwise while an end point and a start point of the gesture are almost identical may correspond to a forward up command.

According to an example, a gesture of holding the control device and twisting or moving the control device counterclockwise while the end point and the start point of the gesture are almost identical may correspond to a forward down command.

According to an example, a gesture of holding the control device and moving the control device in a V-shape may correspond to an confirmation command.

According to an example, a gesture of holding the control device and moving the control device in an X-shape may correspond to a cancel command.

At least one component may be added to or deleted from the components (for example, 110 through 190) shown in the display device 100 of FIG. 3A according to a performance of the display device 100.

It will be easily understood to one of ordinary skill in the art that locations of the components (for example, 110 through 190) may be changed according to the performance or a structure of the display device 100.

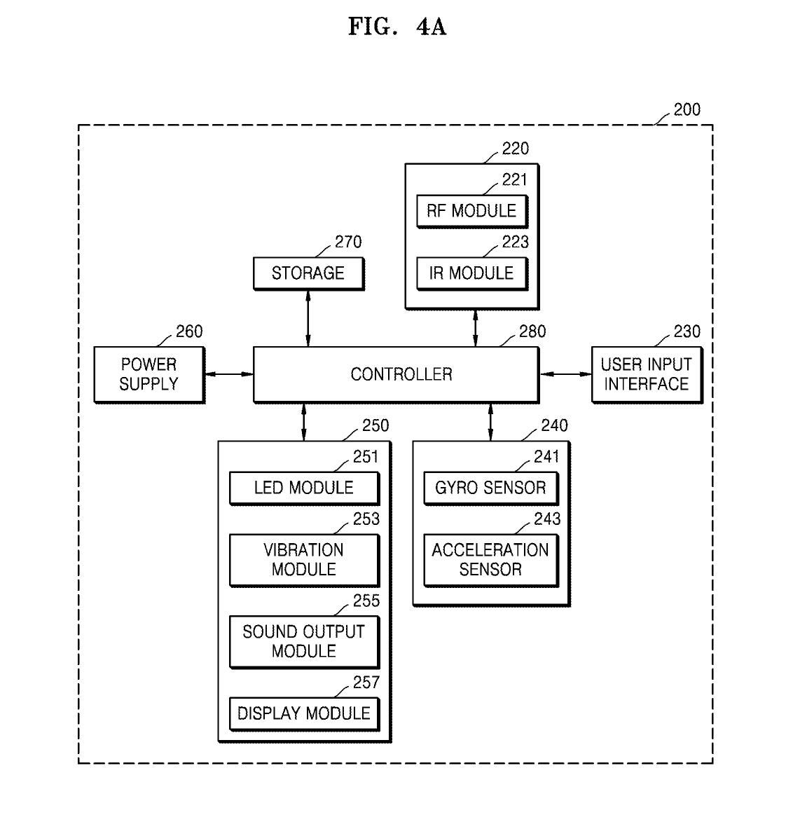

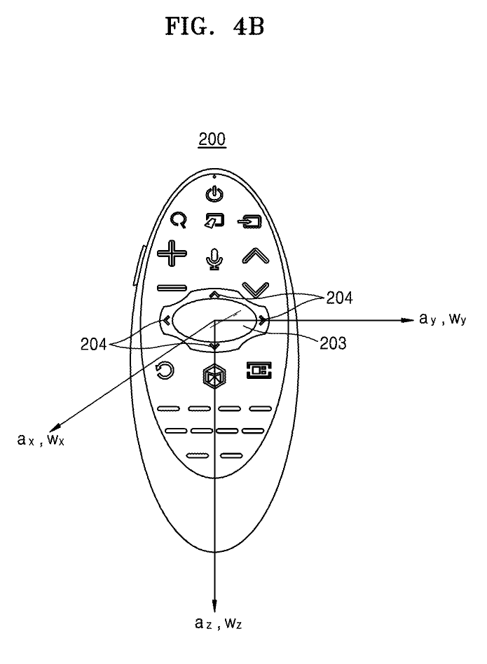

FIG. 4A is a block diagram of a configuration of the control device 200 according to an embodiment.

Referring to FIG. 4A, the control device 200 may include a wireless communicator (e.g., including wireless communication circuitry) 220, a user input interface 230, a sensor 240, an output interface 250, a power supply 260, a storage 270, and a controller 280.

The wireless communicator 220 may transmit and receive a signal to and from the display device 100 according to the embodiments described above. The wireless communicator 220 may include an RF module 221 that transmits and receives the signal to and from the display device 100 according to an RF communication standard. The control device 200 may include an IR module 223 that transmits and receives the signal to and from the display device 100 according to the RF communication standard. The wireless communicator 220 may also include an IR module 223 that transmits and receives the signal to and from the display device 100 according to an IR communication standard.

According to an embodiment, the control device 200 may transmit a signal including information regarding a motion of the control device 200 to the display device 100 through the RF module 221.

The control device 200 may receive a signal transmitted by the display device 100 through the RF module 221. The control device 200 may transmit a command regarding a power on/off, a channel change, a volume change, etc. to the display device 100 through the IR module 223 if necessary.

The user input interface 230 may be configured as a keypad, a button, a touch pad, or a touch screen, etc. A user may manipulate the user input interface 230 to input a command related to the display device 100 to the control device 200. When the user input interface 230 includes a hard key button, the user may input the command related to the display device 100 to the control device 200 through a push operation of the hard key button. When the user input interface 230 includes the touch screen, the user may touch a soft key of the touch screen to input the command related to the display device 100 to the control device 200.

For example, the user input interface 230 may include 4 direction buttons or 4 direction keys. The 4 direction buttons or the 4 direction keys may be used to control a window, a region, an application, or an item that are displayed on the display 115. The 4 direction buttons or the 4 direction keys may be used to indicate up, down, left, and right movements. It will be easily understood to one of ordinary skill in the art that the user input interface 230 may include 2 direction buttons or 2 direction keys instead of the 4 direction buttons or the 4 direction keys.

The user input interface 230 may also include various types of input interfaces such as a scroll key, a jog key, etc. that the user may manipulate. According to an embodiment, the user input interface 230 may receive a user input that drags, touches, or flips, through the touch pad of the control device 200. The display device 100 may be controlled according to a type of the received user input (for example, a direction in which a drag command is input, a time point when a touch command is input, etc.)

The sensor 240 may include a Gyro sensor 241 or an acceleration sensor 243. The Gyro sensor 241 may sense information regarding the movement of the control device 200. As an example, the Gyro sensor 241 may sense information regarding an operation of the control device 200 in relation to X, Y, and Z axes. The acceleration sensor 243 may sense information regarding a movement speed of the control device 200. Thus, as shown in FIG. 4B, both a 3-axis Gyro sensor and a 3-axis acceleration sensor may be used, and thus a perfect 6-dimension movement tracking system may be possible.

Meanwhile, the sensor 240 may further include a distance measurement sensor, and thus a distance between the control device 200 and the display device 100 may be sensed.

The output interface 250 may output an image or voice signal corresponding to a manipulation of the user input interface 230 or corresponding to the signal received from the display device 100. The user may recognize whether the user input interface 230 is manipulated or whether the display device 100 is controlled through the output interface 250.

As an example, the output interface 250 may include an LED module 251 that lights on if the user input interface 230 is manipulated or a signal is transmitted to or received from the display device 100 though the wireless communicator 220, a vibration module 253 that generates vibration, a sound output module 255 that outputs sound, or a display module 257 that outputs an image.

The power supply 260 may supply power to the control device 200. The power supply 260 may stop supplying power when the control device 200 does not move for a certain period of time, thereby reducing power waste. The power supply 260 may resume supplying power when a certain key included in the control device 200 is manipulated.

The storage 270 may store various types of programs, application data, etc. necessary for control or an operation of the control device 200.

According to an embodiment, the storage 270 may include a gesture recognition module that determines a gesture command corresponding to a signal indicating a motion feature of the control device 200 and transmits the determined gesture command to the display device 100.

The controller 280 may control all the matters related to control of the control device 200. The controller 280 may transmit a signal corresponding to a manipulation of a certain key of the user input interface 230 or a signal corresponding to a movement of the control device 200 sensed by the sensor 240 to the display device 100 through the wireless communicator 220.

According to an embodiment, the controller 280 may sense a signal indicating a motion feature of the control device 200 by using the Gyro sensor 241 and the acceleration sensor 243 and may transmit the signal indicating the motion feature to the display device 100 through the wireless communicator 220.

The display device 100 may include a coordinate value calculator (not shown) that calculates a coordinate value of a cursor corresponding to an operation of the control device 200. The coordinate value calculator (not shown) may correct a hand shake or an error from the sensed signal corresponding to the operation of the control device 200 to calculate the coordinate value (x, y) of the cursor that is to be displayed on the display 115. A transmission signal of the control device 200 sensed by the sensor 130 may be transmitted to the controller 180 of the display device 100. The controller 280 may determine information regarding the operation of the control device 200 and a key manipulation from the signal transmitted by the control device 200 and may control the display device 100 in correspondence with the information.

As another example, the control device 200 may calculate a coordinate value of the cursor corresponding to the operation to transmit the coordinate value to the display device 100. In this case, the display device 100 may transmit received information regarding a pointer coordinate value without a separate process of correcting the hand shake or the error to the controller 280.

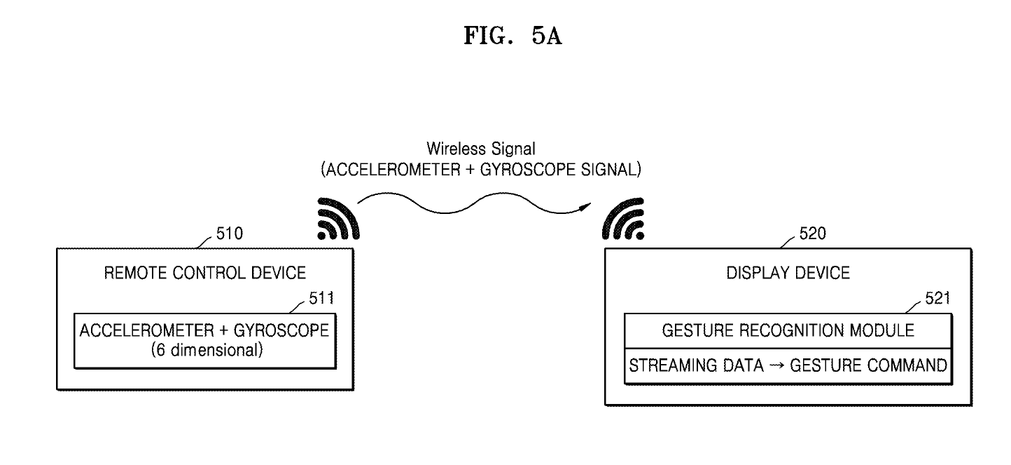

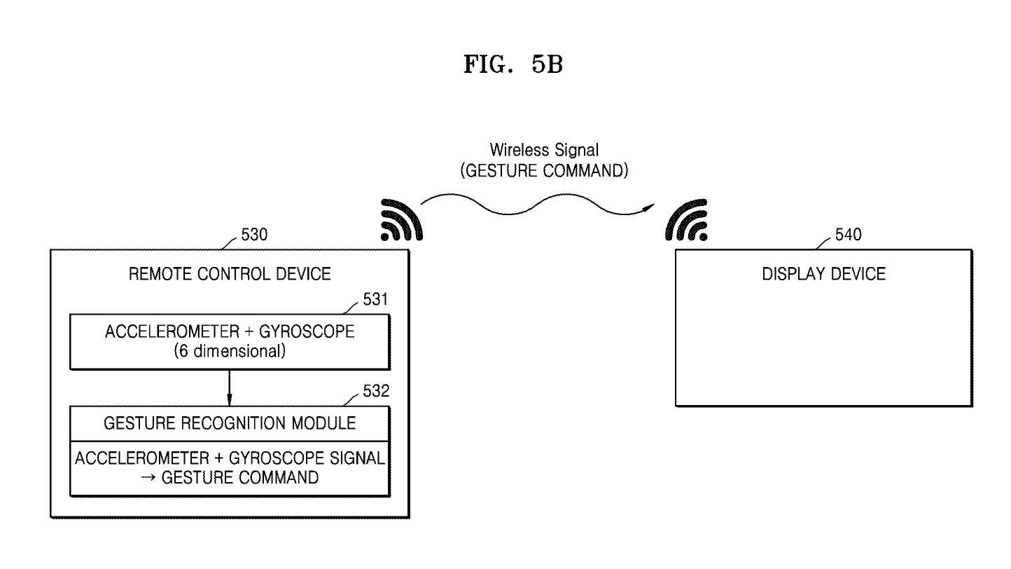

FIG. 5A is a reference diagram for describing a system that receives a motion feature signal from a remote control device 510 and recognizes a gesture in a display device 520 according to an embodiment.

Referring to FIG. 5A, the remote control device 510 may sense a 6 dimensional motion feature signal of the remote control device 510 through an accelerometer and gyroscope 511. The remote control device 510 may transmit the sensed motion feature signal of the accelerometer and gyroscope 511 to the display device 520.

The display device 520 may receive the motion feature signal from the remote control device 510 as streaming data and may determine a gesture command corresponding to the motion feature signal of the streaming data by using a gesture recognition module 521. The display device 520 may act according to the determined gesture command.

FIG. 5B is a diagram for describing a system that determines a gesture command corresponding to a motion feature signal in a remote control device 530 and transmits the determined gesture command to a display device 540 according to an embodiment.

Referring to FIG. 5B, the remote control device 530 may sense a 6 dimensional motion feature signal of the remote control device 530 through an accelerometer and gyroscope 531. A gesture recognition module 532 of the remote control device 530 may receive the sensed motion feature signal of the accelerometer and gyroscope 531 to determine a gesture command corresponding to the motion feature signal. The remote control device 530 may transmit the determine gesture command to the display device 540.

The display device 540 may receive the gesture command from the remote control device 530 and may perform an action corresponding to the received gesture command.

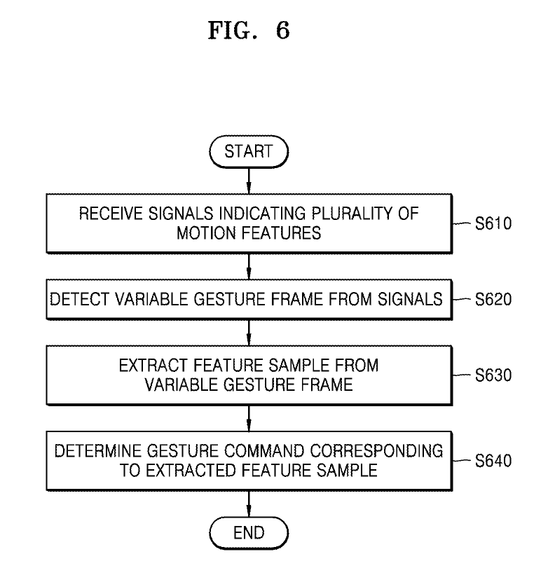

FIG. 6 is a flowchart of a process of recognizing a gesture corresponding to a motion feature signal according to an embodiment. The process of recognizing the gesture corresponding to the motion feature signal may be performed inside of a remote control device that senses the motion feature signal or may be performed inside a display device that receives the motion feature signal from the remote control device as described above.

Referring to FIG. 6, in operation S610, a device may receive signals indicating a plurality of motion features.

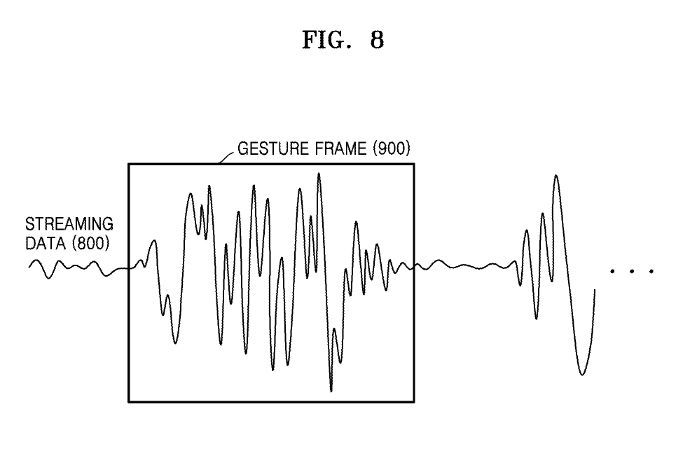

Accelerometer and gyroscope intensity data may be obtained from the remote control device. Such data is referred to as streaming data 800 with reference to FIG. 8.

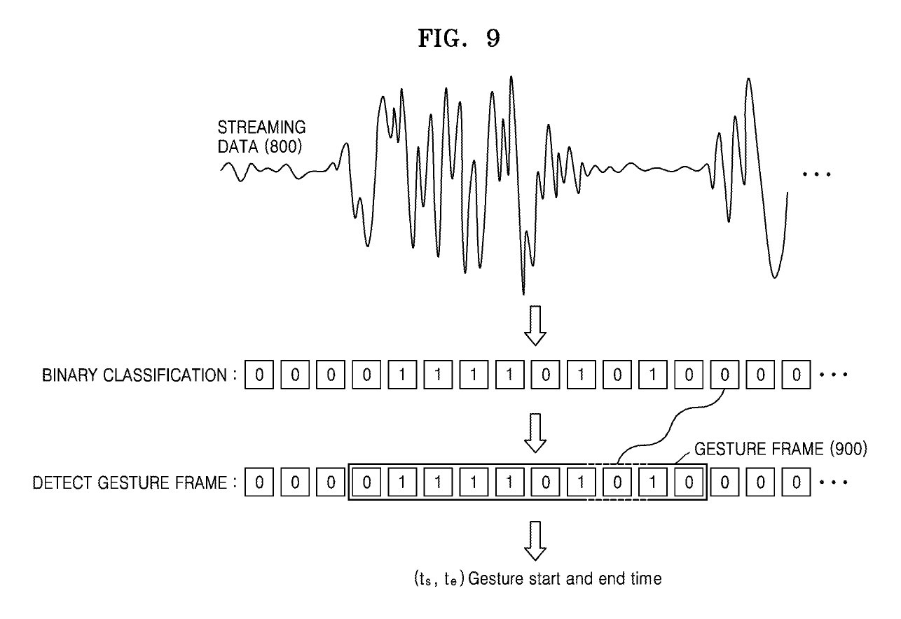

In operation S620, the device may detect a variable gesture frame 900 from the signals indicating the plurality of motion features. Referring to FIG. 8, the variable gesture frame 900 may be detected from the streaming data 800 containing the signals indicating the plurality of motion features. A process of detecting the variable gesture frame 900 from the streaming data 800 will be described with reference to FIG. 9.

The device may classify a signal intensity received from each time stamp into two binary classes, a gesture time stamp, i.e. a gesture component, and a non-gesture time stamp, i.e. a non-gesture component, thereby temporally segmenting the streaming data 800. Referring to FIG. 9, the device may receive the streaming data 800 including the motion feature signal and may classify each time stamp as, for example, two classes, i.e. 0 and 1. Whether a signal is a gesture or not may be determined, for example, based on the following values of the signal.
Amplitude of an accelerometer at a present time
Amplitude of the accelerometer at a previous time
Angular speed at a present time
Angular speed at a previous time

A classifier that classifies signals as a gesture time stamp or a non-gesture time stamp may classify the signals based on label data. For example, the classifier may classify signals as a gesture time stamp or a non-gesture time stamp based on a threshold, for example, signal intensity. Further, the classifier may modify the threshold based on label data, thereby adapting to received data samples. That is, the classifier may be trained. The classifier may adapt according to data indicative of categories respectively corresponding to different gestures, i.e. labeled data. The training of the classifier may also be applied to a system.

Training may be performed, for example, as follows.

For example, 2000 data samples, i.e. 1000 gesture data samples and 1000 non-gesture data samples, may be obtained, and amplitude values of an accelerometer and angular speeds at a previous time and a present time described above with respect to each data sample may be obtained. Label information of each data sample may be, for example, a one (1) for each data sample which is a gesture and a zero (0) for each data sample which is a non-gesture, or vice versa. Such data samples and information may be input into the system, and thus the system may be adapted based on whether each data sample is a gesture or a non-gesture. If the system is trained, when a new data sample is input to the system, the system may classify the new data sample as the gesture or the non-gesture.

According to embodiments, the variable gesture frame 900 may be determined in various ways.

According to an embodiment, a start point of the variable gesture frame 900 may be determined as a time point where the number of 1's appearing on the window is sufficient for determining the variable gesture frame 900. According to another embodiment, the start time of the variable gesture frame 900 may be a time point where the ratio of 0's to 1s, or vice versa, appearing on the window exceeds a previously determined ratio of 0s to 1's.

According to an embodiment, an end time of the variable gesture frame 900 may be determined as a time point where the number of 0's appearing on the window is sufficient for determining the variable gesture frame 900. According to another embodiment, the end time of the variable gesture frame 900 may be a time point where the ratio of 0's and 1's appearing on the window decreases below a previously determined ratio of 0's to l's.

According to an embodiment, the length of the variable gesture frame 900 may be increased in a section of the variable gesture frame 900 based on a determination whether a previously determined number of 1's always exists in the window. According to another embodiment, the length of the variable gesture frame 900 may be increased in a section of the variable gesture frame 900 based on a determination whether the ratio of 0's and 1's appearing on the window exceeds a previously determined ratio of 0's to l's for more than a set period.

Then, a window time length may be adjusted to slide a temporal window and include a gesture according to streaming data, and thus a start time and an end time of a gesture frame may be extracted. The start time of the gesture frame may be defined as a time point where the sufficient number of l's appears on the window. The end time of the gesture frame may be defined as a time point where the sufficient number of 0's appears on the window. To increase a size of the window, the previously determined number of 1 needs to exist in the window always. If the number of 1 is smaller than the threshold value in the window, an increase in the size of the window stops. Data between the start time and the end time of the gesture frame may is the gesture frame. As described above, the length of the gesture frame may be variable in the present embodiment. A minimum size and a maximum size may be defined by using an empirical knowledge. For example, it may take 0.2 seconds to input a fast gesture such as swiping. It may take 0.6 seconds to input a longer gesture such as a circle.

As described above, an amplitude of the gesture frame may not be normalized, thereby preventing valid information from being lost in the present embodiment.

For example, a gesture time stamp is classified as a 1, and a non-gesture time stamp is classified as a 0. If streaming data is received, once a previously determined ratio of 0's to 1's is satisfied, it may be determined that a gesture has started, and accordingly, a start of the gesture, i.e. a start of the gesture frame, may be determined. If the ratio of 0's and 1's is continuously checked in the received streaming data and continuously satisfies the previously determined ratio, it may be determined that the gesture is still being input and thus a window of the gesture frame may continue to be increased. When the number of 0's appearing on the window of the gesture frame is continuous and equals a previously determined number of 0's, it may be determined that the gesture is no longer being input. In this regard, the window of the gesture frame ends and thus an end point of the gesture frame may be determined. As described above, a frame including valid gesture information may be determined by continuously increasing and varying a length of the gesture frame while determining the gesture and keeping the length of the gesture frame variable.

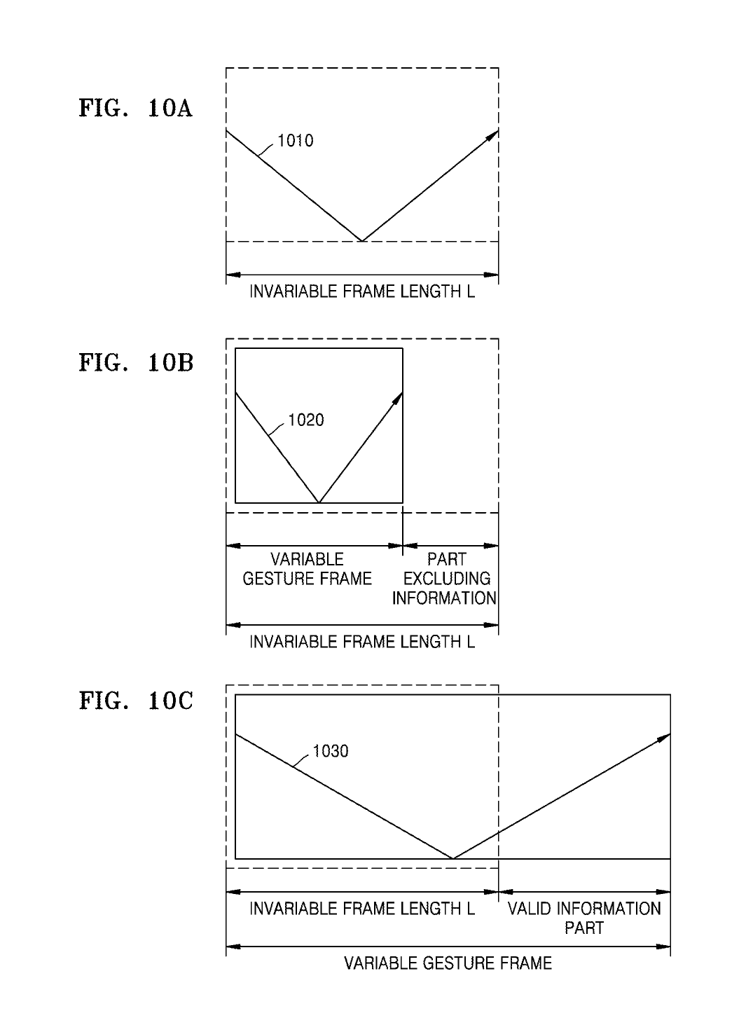

FIGS. 10A through 10C are reference diagrams for describing an invariable gesture frame.

The invariable gesture frame will now be described with reference to FIGS. 10A through 10C.

FIG. 10A illustrates an example of a V shaped gesture 1010. A device detects the V shaped gesture 1010 by setting an invariable frame length L other than a variable frame length.

V shaped gestures input by different users may vary according to personality of each user, age, etc. For example, V shaped gestures input 1020 by relatively younger users may be short and quick as shown in FIG. 10B. V shaped gestures input 1030 by relatively older users may be longer and slower as shown in FIG. 10C.

Regarding various gesture inputs of users, if a gesture frame having an invariable frame length L is used for detecting gesture inputs, the invariable frame length L may include a portion of the gesture frame which does not include information, as illustrated in FIG. 10B.

In another example, if the gesture frame having an invariable frame length L is used for detecting gesture inputs, a portion of valid information included in the long gesture of FIG. 10C may be unintentionally excluded.

Therefore, due to the variable length L of the gesture frame according to example embodiments of the disclosure, valid information may be included, invalid or unnecessary information may be excluded, and unintended exclusion of valid information may be minimized or prevented.

In operation S630, the device may extract the feature samples from the variable gesture frame 900.

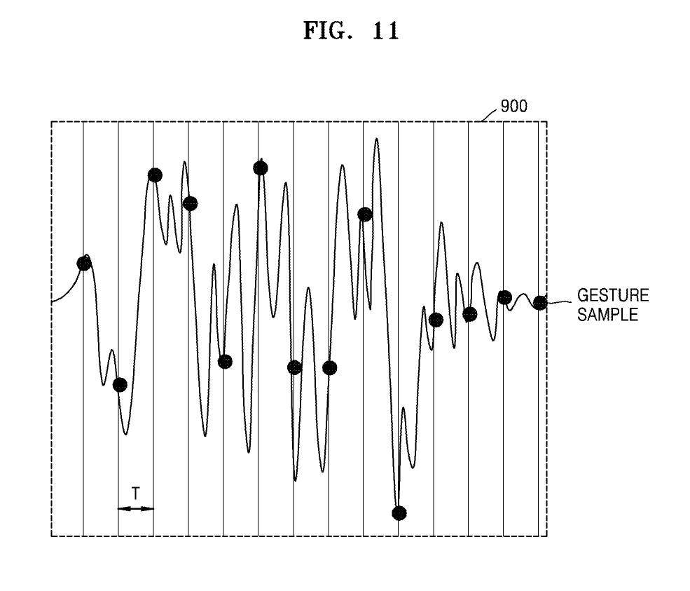

FIG. 11 is a reference diagram for describing a method of extracting a gesture sample from a gesture frame according to an embodiment. Referring to FIG. 11, a device may extract feature samples from the variable gesture frame 900.

The gesture frame may be generated by sampling a signal at a sampling frequency of 100 Hz (100 times per second).

The gesture sample is represented by a number of sample points P defined in a training step. Gesture frames may be expanded by interpolation. A time interval T for sampling the signal may be defined as a length of the gesture frame divided by P. In FIG. 11, a gesture sample point is indicated as a dot.

For example, when the length of the gesture frame is 0.3 seconds, for example, a signal in the gesture frame may be sampled 40 times according to a constant time interval T equal to (0.3/40) seconds.

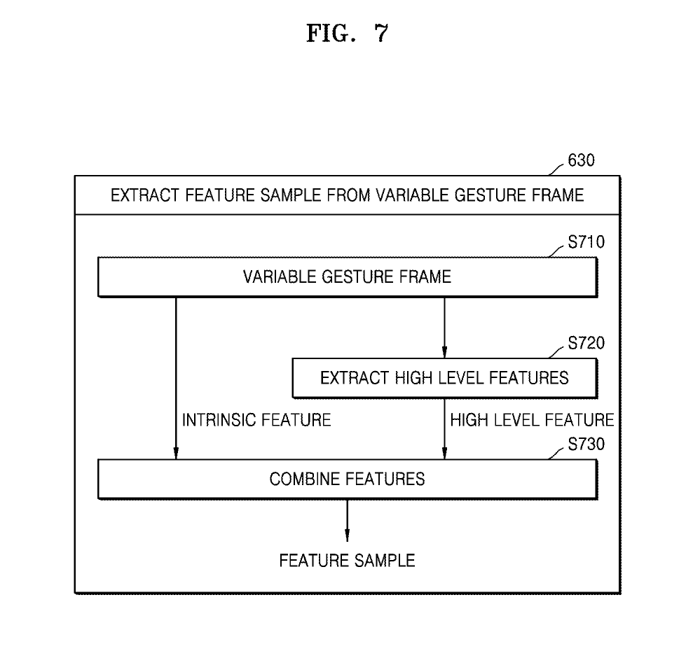

FIG. 7 is a detailed flowchart of a process 630 of extracting a feature sample from a variable gesture frame according to an embodiment.

Referring to FIG. 7, in operation S710, the variable gesture frame may be received.

In operation S720, a device may extract a high level feature from the variable gesture frame.

To extract the high level feature, the device may obtain a gesture sample from the gesture frame in FIG. 11.

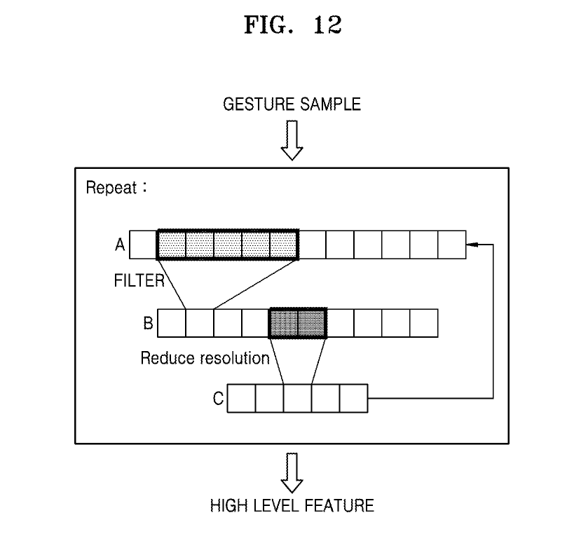

FIG. 12 is a reference diagram for describing a method of extracting a high level feature from a gesture sample according to an embodiment.

Referring to FIG. 12, a device may apply a local filter to the gesture sample and may reduce resolution. A temporal shift and a distortion invariance may be obtained by reducing the resolution.

In operation of extracting the high level feature, a filter operation and a dimension reduction operation are repeated.

In operation S730, the device may obtain a feature sample by combining an intrinsic feature of a variable gesture frame and the extracted high level feature. The intrinsic feature may be important information indicating an essence of a signal and may include, for example, a duration of a gesture, energy of the gesture, an entropy of the gesture.

Referring to FIG. 6, in operation S640, the device may determine the gesture command corresponding to the extracted sample.

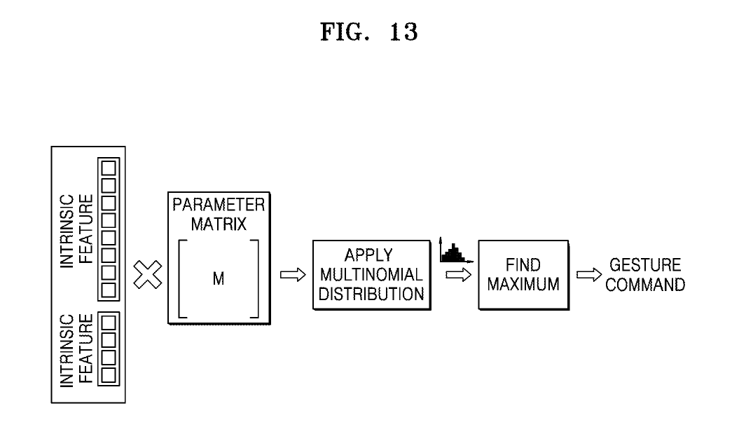

FIG. 13 is a reference diagram for describing a method of extracting a gesture command corresponding to a signal that a combination of an intrinsic feature and a high level feature according to an embodiment.

Referring to FIG. 13, a device may determine a gesture category of a gesture frame by multiplying a feature sample obtained by combining the intrinsic feature and the high level feature and finding a maximum value of a multinomial distribution calculated in a result of multiplication. A weight of a matrix may be automatically set during a supervised training procedure.

Application examples of embodiments will be described.

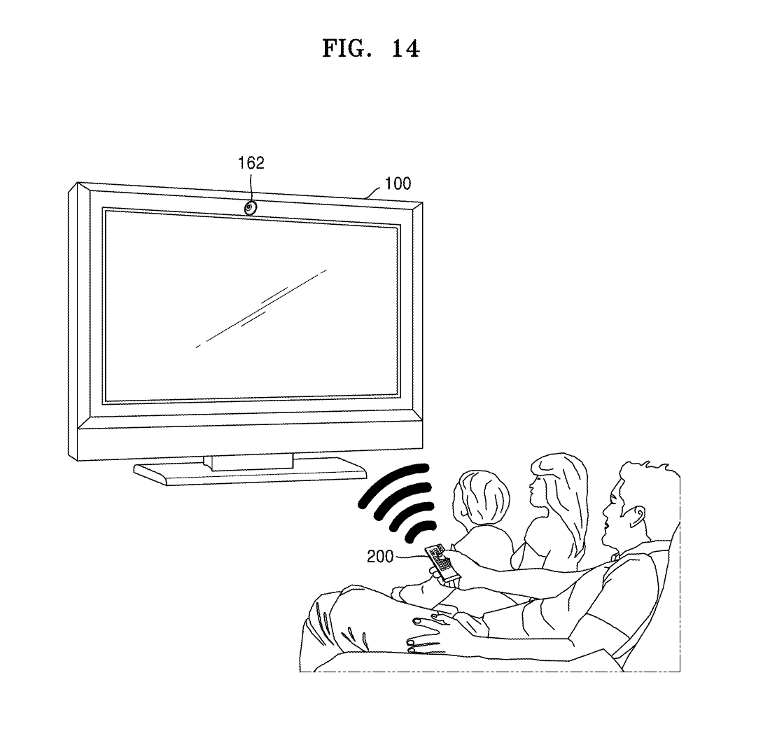

FIG. 14 is a diagram for describing an application of adapting a gesture with respect to each of a plurality of users.

For example, the plurality of users who use the display device 100 may be present at home. The users may have slightly different motions for the same gesture. Thus, according to an embodiment, each user may train the display device 100 by repeating a specific gesture a certain number of times so that the display device 100 is able to effectively recognize a gesture made by each user. For example, each user may be recognized by capturing an image of each user by using the camera 162 of the display device 100 or receiving a voice input from each user via the microphone 161. For example, if a user A among the plurality of users frequently has a short V shaped gesture as shown in FIG. 10B, the display device 100 may store information indicating the user A has a short V shaped gesture. When the user A is recognized by the display device 100, the display device 100 may be able to more accurately perform gesture recognition corresponding to user A based on the stored information (i.e., the training information). If a user B among the plurality of users frequently has a long V shaped gesture as shown in FIG. 10C, the display device 100 may store information indicating the user B has a long V shaped gesture. When the user B is recognized by the display device 100, the display device 100 may be able to more accurately perform gesture recognition corresponding to user B based on the stored information.

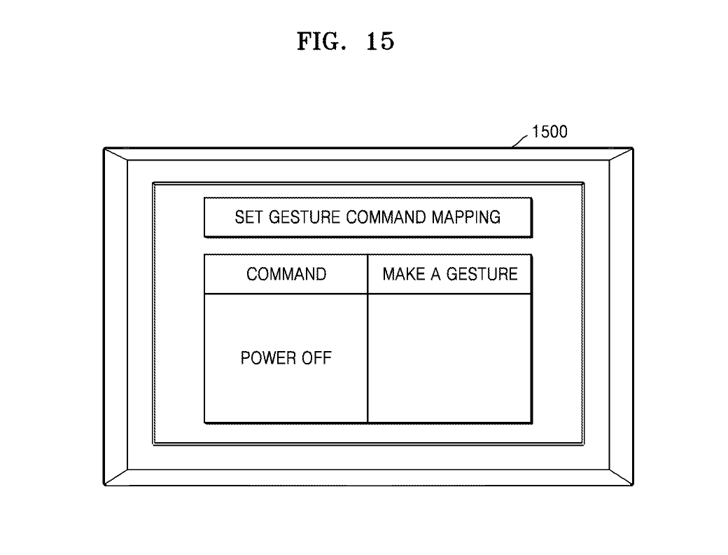

FIG. 15 is a diagram for describing an application example defining a customized gesture.

For example, when a display device is released, a basically set gesture and command mapping table may be stored in the display device. However, a user may wish to change gesture and command mapping as desired while using the display device. For example, the user may wish a gesture to move a control device to the right for a volume-up command other than a gesture to move the control device up and may wish a gesture to move the control device to the left for a volume-down command other than a gesture to move the control device down.

In this case, the user may define the gesture and command mapping as desired through a user interface menu 1500 provided by the display device.

The user may also customize a gesture that is not stored in the display device beyond a given gesture range stored in the display device. For example, the user may define a gesture to move the control device in a diagonal direction, i.e. right and up, for a power-off command of the display device.

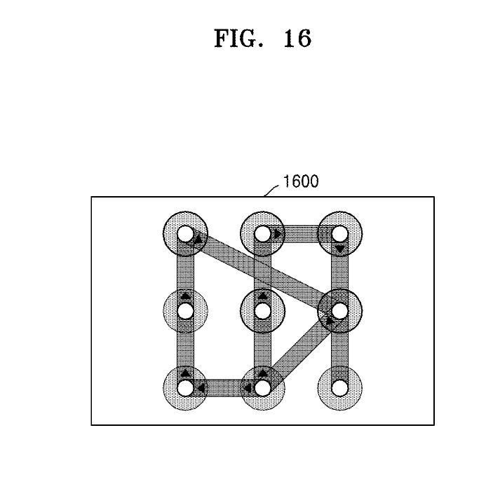

FIG. 16 is a diagram for describing an application example defining a signature gesture 1600.

For example, when a plurality of users share and use one display device, each user may need an operation similar to a log-in to his/her account in order to use the display device in a desired format. In this case, each user may set and perform the signature gesture 1600 shown in FIG. 16 in order to use the display device in the desired format, thereby logging into his/her account of the display device.

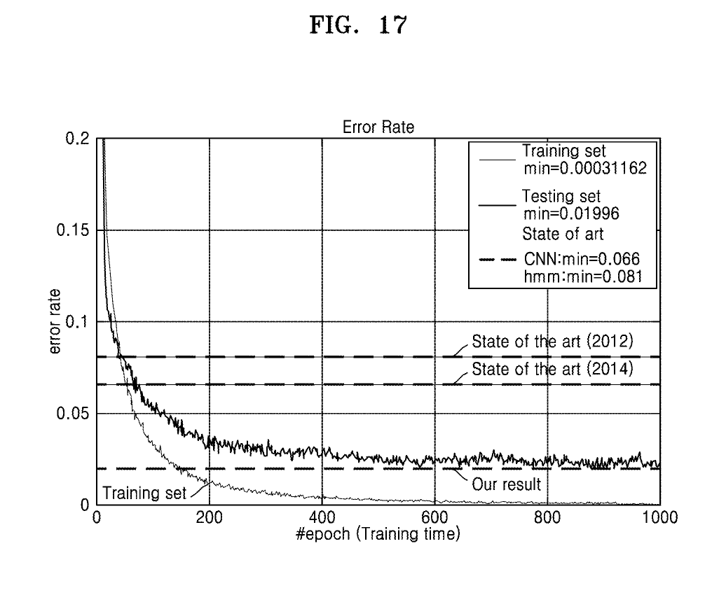

Performance of a system to which a gesture recognition method is applied according to an embodiment will be described with reference to FIGS. 17 through 19 below.

To evaluate the system according to an embodiment, two different sources of data is used.

Samsung Smart Remote 2014 in which an accelerometer and a Gyroscope sensor are mounted transmits data at a frequency of 100 Hz via Bluetooth. A TV system receives row data through a USB dongle.

28 participants use a 6D motion gesture (6DMG) database containing 20 pieces of gesture data. All data sets contain 5615 gestures.

Accuracy of a proposed system that recognizes a gesture is tested by using the 6DMG database in order to compare proposed system result with previous tasks on the same base.

A graph of FIG. 17 shows that a technology proposed according to an embodiment has a quite low error rate compared to an error rate of a technology level in 2012 and 2014.

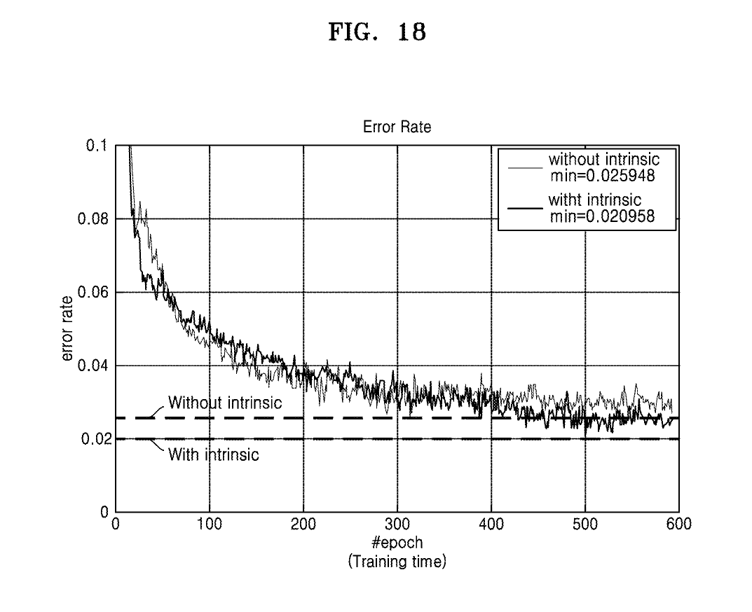

FIG. 18 is a graph showing a difference in performance when an intrinsic feature is used and is not used according to an embodiment.

The graph of FIG. 18 shows an influence when a signal length and signal energy are used as the intrinsic feature. Referring to FIG. 18, an error rate of a system using the intrinsic feature is further lower. That is, the intrinsic feature such as the signal length and a signal intensity may be used, resulting in a further high accuracy of the system.

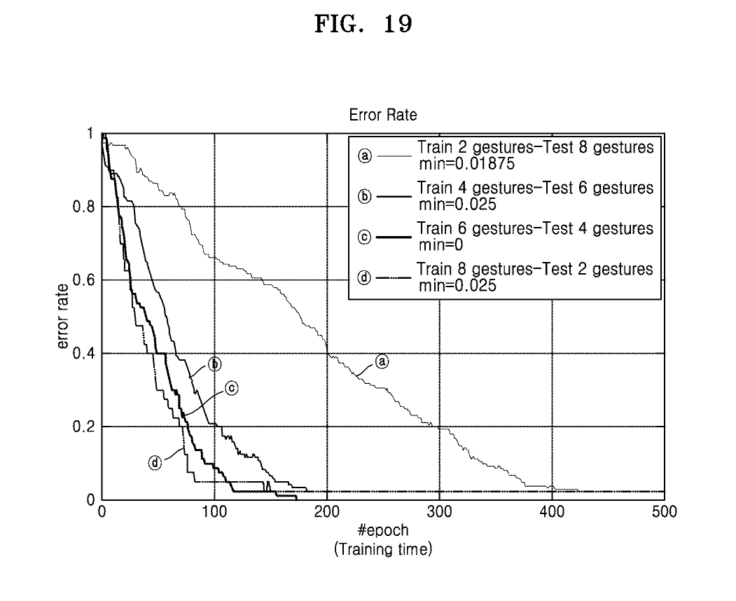

FIG. 19 is a graph showing performance when a new gesture is customized according to an embodiment.

Referring to FIG. 19, the graph shows an error rate when 2 gestures are trained, an error rate when 4 gestures are trained, an error rate when 6 gestures are trained, and an error rate when 8 gestures are trained. A result of FIG. 19 shows that a user may define the new gesture on a system according to the present embodiment from, and the system may memorize and recognize the new gesture with accuracy by using only two samples.

According to the embodiments, a movement of inputting a user gesture while holding a control device such as a remote control may be used to control a function of a display device or a computing device, thereby increasing user convenience.

More specifically, the gesture may be recognized by varying, for example, the length of a gesture frame, thereby enhancing gesture recognition performance.

Furthermore, not only a high level feature of a signal corresponding to the gesture frame but also an intrinsic feature may be further considered, and recognition of the signal may be performed without a loss of valid information, thereby enhancing recognition performance.

A display method according to an embodiment may be written as program commands executable via any computer means and recorded in a computer-readable recording medium. The computer-readable recording medium may include a program command, a data file, and a data structure solely or in combination. Program commands recorded in the computer-readable recording medium may be specifically designed and configured for the disclosed embodiments, or may be well known to and usable by one of ordinary skill in the art of computer software. Examples of the computer-readable recording medium include magnetic media (e.g., hard disks, floppy disks, and magnetic tapes), optical media (e.g., CD-ROMs and DVDs), magneto-optical media (e.g., floptical disks), and hardware devices specifically configured to store and execute program commands (e.g., ROMs, RAMs, and flash memories). Examples of program commands include not only machine language codes prepared by a compiler, but also high-level language codes executable by a computer by using an interpreter.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

What is claimed is:

1. A gesture recognition method comprising:
receiving signals of a plurality of motion features;
detecting a variable gesture frame from the signals;
extracting a feature sample from the variable gesture frame; and
determining a gesture command corresponding to the extracted feature sample.

2. The gesture recognition method of claim 1, wherein the detecting of the variable gesture frame comprises:
determining whether each of the signals is a gesture component or a non-gesture component; and
determining a length of the variable gesture frame based on a ratio of the gesture components to the non-gesture components.

3. The gesture recognition method of claim 2, wherein the determining of the length of the variable gesture frame based on the ratio of the gesture components to the non-gesture components comprises:
determining a threshold value based on a ratio of the gesture components to the non-gesture components which are detected in a predefined section of the signals; and
setting a start point of the variable gesture frame based on point in time when the ratio of the gesture components to the non-gesture components of the signals equals the threshold value, increasing the length of the variable gesture frame based on whether the ratio of the gesture components to the non-gesture components of the signals exceeds the threshold value, and determining an end point of the variable gesture frame based on a point in time when the ratio of the gesture components to the non-gesture components of the signals decreases below the threshold value.

4. The gesture recognition method of claim 1, wherein the extracting of the feature sample from the variable gesture frame comprises:
extracting an intrinsic feature from the variable gesture frame;
extracting a high level feature from a gesture sample of the variable gesture frame; and
obtaining the feature sample based on a combination of the intrinsic feature and the high level feature.

5. The gesture recognition method of claim 1, wherein the receiving of the signals of the plurality of motion features comprises: receiving the signals of the plurality of motion features from an accelerometer and a gyroscope.

6. A non-transitory computer-readable recording medium having recorded thereon a program, which when executed by a computer, performs a gesture recognition method comprising:
receiving signals of a plurality of motion features;
detecting a variable gesture frame from the signals;
extracting a feature sample from the variable gesture frame; and
determining a gesture command corresponding to the extracted feature sample.

7. The non-transitory computer-readable recording medium of claim 6, wherein the detecting of the variable gesture frame comprises:
determining whether each of the signals is a gesture component or a non-gesture component; and
determining a length of the variable gesture frame based on a ratio of the gesture components to the non-gesture components.

8. The non-transitory computer-readable recording medium of claim 7, wherein the determining of the length of the variable gesture frame based on the ratio of the gesture components to the non-gesture components comprises:
determining a threshold value based on a ratio of the gesture components to the non-gesture components which are detected in a predefined section of the signals; and
setting a start point of the variable gesture frame based on a point in time when the ratio of the gesture components to the non-gesture components of the signals equals the threshold value, increasing the length of the variable gesture frame based on whether the ratio of the gesture components to the non-gesture components of the signals exceeds the threshold value, and determining an end point of the variable gesture frame based on a point in time when the ratio of the gesture components to the non-gesture components of the signals decreases below the threshold value.

9. The non-transitory computer-readable recording medium of claim 6, wherein the extracting of the feature sample from the variable gesture frame comprises:
extracting an intrinsic feature from the variable gesture frame;
extracting a high level feature by filtering a gesture sample of the variable gesture frame; and
obtaining the feature sample by combining the intrinsic feature and the high level feature.

10. The non-transitory computer-readable recording medium of claim 6, wherein the receiving of the signals of the plurality of motion features comprises: receiving the signals of the plurality of motion features from an accelerometer and a gyroscope.

11. A computing device comprising:
a communicator comprising communication circuitry configured to receive, from a control device, signals of a plurality of motion features; and
a controller configured to determine a gesture command corresponding to the received signals and to control the computing device to perform an action corresponding to the gesture command, and
wherein the controller, in determining the gesture command, is configured to detect a variable gesture frame from the received signals, to extract a feature sample from the variable gesture frame, and to determine a gesture command corresponding to the extracted feature sample.

12. The computing device of claim 11, wherein the controller, in detecting the variable gesture frame, is configured to determine whether each of the signals is a gesture component or a non-gesture component and determine a length of the variable gesture frame based on a ratio of the gesture components to the non-gesture components.

13. The computing device of claim 12, wherein the controller is configured to determine a threshold value based on a ratio of the gesture components to the non-gesture components which are detected in a predefined section of the signals, to set a start point of the variable gesture frame based on a point in time when the ratio of the gesture components to the non-gesture components of the signals equals the threshold value, to increase the length of the variable gesture frame based on whether the ratio of the gesture components to the non-gesture components of the signals exceeds the threshold value, and to determine an end point of the variable gesture frame based on a point in time when the ratio of the gesture components to the non-gesture components of the signals decreases below the threshold value.

14. The computing device of claim 11, wherein the controller, in extracting the feature sample from the variable gesture frame, is configured to extract an intrinsic feature from the variable gesture frame, to extract a high level feature by filtering a gesture sample of the variable gesture frame, and to obtain the feature sample based on a combination of the intrinsic feature and the high level feature.

15. A control device comprising:
a communicator comprising communication circuitry;
a sensor configured to sense motion of the control device and signals of a plurality of motion features; and
a controller configured to determine a gesture command corresponding to the signals sensed by the sensor and to control the communicator to transmit the gesture command to an external device, and
wherein the controller, in determining the gesture command, is configured to detect a variable gesture frame from the signals sensed by the sensor, to extract a feature sample from the variable gesture frame, and to determine a gesture command corresponding to the extracted feature sample.

16. The control device of claim 15, wherein the controller, in detecting the variable gesture frame, is configured to determine whether each of the signals is a gesture component or a non-gesture component and determine a length of the variable gesture frame based on a ratio of the gesture components to the non-gesture components.

17. The control device of claim 16, wherein the controller is configured to determine a threshold value based on a ratio of the gesture components to the non-gesture components which are detected in a predefined section of the signals as a threshold value, to set a start point of the variable gesture frame based on a point in time when the ratio of the gesture components to the non-gesture components of the signals equals the threshold value, to increase the length of the variable gesture frame based on whether the ratio of the gesture components to the non-gesture components of the signals exceeds the threshold value, and to determine an end point of the variable gesture frame based on a point in time when the ratio of the gesture components to the non-gesture components of the signals decreases below the threshold value.

18. The control device of claim 15, wherein the controller, in extracting the feature sample from the variable gesture frame, is configured to extract an intrinsic feature from the variable gesture frame, to extract a high level feature by filtering a gesture sample of the variable gesture frame, and to obtain the feature sample based on a combination of the intrinsic feature and the high level feature.
